(19) United States
(12) Patent Application Publication
(10) Pub. No.: US 2025/0170925 A1
(43) Pub. Date: May 29, 2025

(54) SEAT SLIDER

(71) Applicant: TF-METAL Co., Ltd., Kosai-shi (JP)

(72) Inventor: Takashi IMAMURA, Hamamatsu-shi (JP)

(73) Assignee: TF-METAL Co., Ltd., Kosai-shi (JP)

(21) Appl. No.: 18/959,414

(22) Filed: Nov. 25, 2024

(30) Foreign Application Priority Data
Nov. 28, 2023 (JP) 2023-200397

(51) Int. Cl. B60N 2/07; B60N 2/02; B60N 2/06

(52) U.S. Cl. CPC B60N 2/0727; B60N 2/067; B60N 2/02253

(57) ABSTRACT

A seat slider includes a lower rail, an upper rail, a screw shaft, a nut screwed to the screw shaft, an elastic member retaining the nut vertically movably, and a bracket fixing the elastic member to a bottom wall of the lower rail. The nut is inserted in the elastic member having a box shape. The bracket supports the elastic member, and includes a first bracket and a second bracket respectively facing an upper face and a lower face of the nut. The nut has a shape of a cross when viewed at a section perpendicular to an axis of the screw shaft, and includes an upper projection extending through a first rectangular hole of the first bracket and a lower projection extending through a second rectangular hole of the second bracket.

### BACKGROUND

The present disclosure relates to a seat slider of a seat for a vehicle, in particular a seat slider structured to electrically move a seat in a front-and-rear direction of the vehicle.

Japanese Patent Application Publication JP 2010-047172 A, corresponding to US 2010/0044542 A1, discloses an electric seat slider including a nut covered by an elastic member and including a bracket surrounding and retaining the nut. This allows adjustment of an axis of a screw hole of the nut and an axis of a screw shaft. The nut is supported movably or slidably in a vertical direction and a right-and-left direction, and moves to align the axis of the screw hole of the nut and the axis of the screw shaft. This serves to suppress noise and vibration caused by rotation of the screw shaft.

The electric seat slider above is likely to undergo biting between the screw shaft and the elastic member upon mechanically colliding an upper rail with a lower rail and thereby regulating a stroke range of the upper rail with respect to the lower rail, because the screw shaft continues rotating even after stopping of the upper rail and compresses the elastic member. Such biting increases a force required for operation of the screw shaft during a reverse operation to reverse the screw shaft, and causes noise and vibration.

As a countermeasure against this problem, each of Japanese Patent Application Publication JP 2022-030546 A and Japanese Patent Application Publication JP 2011-031667 A discloses an electric seat slider including a nut including a projection. The projection of the nut is formed on a facing surface of the nut that faces a bracket surrounding the nut, and allows the nut to directly contact with the bracket. This suppresses an elastic member from being compressed more than intended.

### SUMMARY

The electric seat slider disclosed by the above Japanese Patent Application Publications JP 2022-030546 A and JP 2011-031667 A includes the projection on the facing surface of the nut. This complicates a shape of the nut, deteriorates workability of the nut, and increases a manufacturing cost of the nut. Furthermore, the projection on the facing surface of the nut also complicates a shape of the elastic member, because the elastic member has to be shaped to avoid the projection. This increases a manufacturing cost of the elastic member.

In view of the foregoing conventional circumstances, it is desirable to simplify a nut and an elastic member in shape and improve them in workability, without deteriorating a function for adjustment of an axis of a screw hole of the nut and an axis of a screw shaft.

According to one aspect of the present disclosure, a seat slider for a vehicle comprises: a lower rail extending in a front-and-rear direction of the vehicle; an upper rail structured to be movable in a longitudinal direction of the lower rail relatively with respect to the lower rail; a screw shaft that is mounted to a first one of the lower rail and the upper rail so as to be rotatable, and extends in the longitudinal direction of the lower rail; a nut that is mounted to a second one of the lower rail and the upper rail, includes a screw hole extending through the nut in the front-and-rear direction, and is screwed to the screw shaft; an elastic member having a rectangular box shape and including: a ceiling wall covering an upper face of the nut and including a ceiling wall rectangular hole; a rectangular tubular wall extending from a rim of the ceiling wall and covering front, rear, right, and left faces of the nut; and a through hole overlapping with the screw hole of the nut in the front-and-rear direction; and a bracket supporting the elastic member so as to cover the front face, the rear face, the upper face, and a lower face of the nut from outside of the elastic member. The bracket includes a first bracket and a second bracket. The first bracket includes: a first upper wall facing the upper face of the nut and including a first rectangular hole; a pair of first walls extending downwardly from ends in the front-and-rear direction of the first upper wall and respectively facing the front face and the rear face of the nut; and a pair of first mounting walls extending in the front-and-rear direction from lower ends of the pair of first walls so as to extend away from each other. The second bracket includes: a second upper wall facing the lower face of the nut and including a second rectangular hole; a pair of second walls extending downwardly from ends in the front-and-rear direction of the second upper wall and respectively facing the pair of first walls of the first bracket; and a pair of second mounting walls that extend in the front-and-rear direction from lower ends of the pair of second walls so as to extend away from each other, and are mounted to a bottom wall of the lower rail together with the pair of first mounting walls of the first bracket. The nut has a shape of a cross when viewed at a section perpendicular to a direction of an axis of the screw shaft, and includes: an upper projection extending through the ceiling wall rectangular hole of the ceiling wall of the elastic member and through the first rectangular hole of the first upper wall of the first bracket; and a lower projection projecting downwardly via an open face of the elastic member and extending through the second rectangular hole of the second upper wall of the second bracket.

The above aspect of the present disclosure serves to simplify a nut and an elastic member in shape and improve them in workability, without deteriorating a function for adjustment of an axis of a screw hole of the nut and an axis of a screw shaft.

### BRIEF DESCRIPTION OF DRAWINGS

FIG. 1 is an exploded oblique view of a seat slider according to an embodiment of the present disclosure.

FIG. 2 is an oblique view of the seat slider according to the embodiment.

FIG. 3 is a cross sectional view of the seat slider along a line A-A shown in FIG. 2.

FIG. 4 is an oblique view of a nut in the seat slider according to the embodiment.

FIG. 5 is an oblique view of an elastic member employed in the seat slider according to the embodiment.

FIG. 6 is a side view showing how the nut is installed.

FIG. 7 is a longitudinal sectional view in a vehicle front-and-rear direction corresponding to FIG. 6, which shows how the nut is installed.

FIG. 8 is a cross sectional view along a line B-B shown in FIG. 7, which shows how the nut is installed.

### DETAILED DESCRIPTION

The following describes an embodiment exemplifying a seat slider applied to a seat for a vehicle, with reference to the drawings.

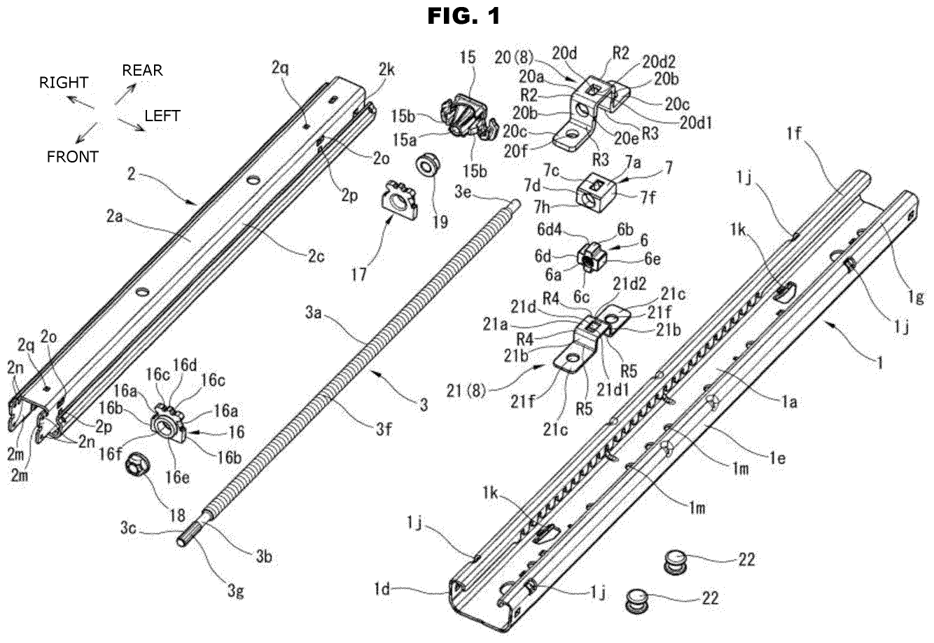

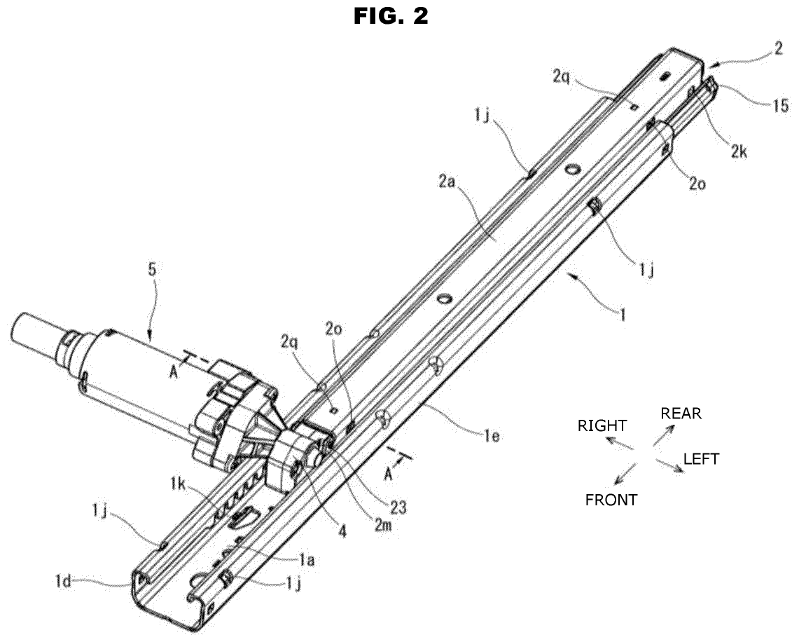

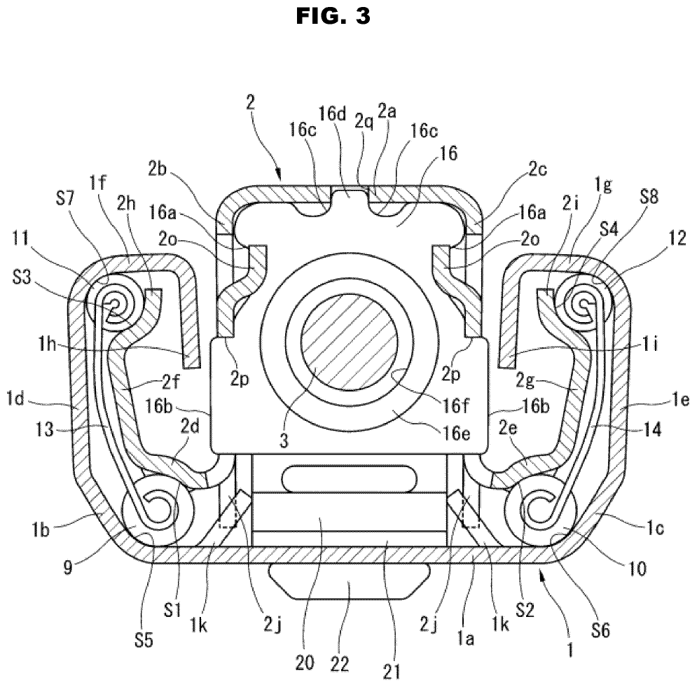

FIG. 1 is an exploded oblique view of the seat slider according to the present embodiment. FIG. 2 is an oblique view of the seat slider. FIG. 3 is a cross sectional view of the seat slider along a line A-A shown in FIG. 2. In the following, “vehicle front-and-rear direction” is referred to as a longitudinal direction of a lower rail 1. With reference to FIGS. 1 and 2, the front side in the vehicle front-and-rear direction is a side in which an electric motor 5 is disposed, and the rear side in the vehicle front-and-rear direction is a side in which an end cap 15 is disposed. In addition, “vertical direction” is referred to as a vertical direction when the seat slider is fixed on a floor of a vehicle body: in other words, a direction perpendicular to the floor of the vehicle body, i.e., a height direction of the vehicle body. “Right-and-left direction” is referred to as a right-and-left direction when the seat slider is fixed to the floor of the vehicle body: in other words, a direction perpendicular to both of the vehicle front-and-rear direction and the vertical direction.

The seat slider in the vehicle includes the lower rail 1, an upper rail 2, a screw shaft 3, a gearbox 4, the electric motor 5, a nut 6, an elastic member 7, and a bracket 8. The lower rail 1 extends in the vehicle front-and-rear direction. The upper rail 2 is relatively movable with respect to the lower rail 1 in the longitudinal direction of the lower rail 1, and forms a rail assembly with the lower rail 1. The screw shaft 3 is mounted to the upper rail 2 so as to be rotatable, and extends in the longitudinal direction of the lower rail 1. The gearbox 4 includes a gear mechanism structured to rotate the screw shaft 3. The electric motor 5 exerts rotational force on the screw shaft 3 via the gear mechanism of the gearbox 4. The nut 6 is mounted to the lower rail 1, and is screwed to the screw shaft 3. The elastic member 7 surrounds and retains the nut 6. The bracket 8 fixes the nut 6 to the lower rail 1 via the elastic member 7 such that the nut 6 is movable in the vertical direction.

The lower rail 1 is formed by bending right and left ends of a slender metallic thin plate by press working. As shown in FIG. 3, the lower rail 1 includes a bottom wall 1a, a pair of first inclined walls 1b and 1c, a pair of outer side walls 1d and 1e, a pair of upper walls 1f and 1g, and a pair of inner side walls 1h and 1i. The bottom wall 1a is fixed to the floor of the vehicle body via a fixing member not shown. The first inclined walls 1b and 1c extend outwardly from right and left ends of the bottom wall 1a, as bent obliquely upwardly. The outer side walls 1d and 1e extend from upper ends of the first inclined walls 1b and 1c, as bent upwardly. The upper walls 1f and 1g extend from upper ends of the outer side walls 1d and 1e, as bent inwardly. The inner side walls 1h and 1i extend from inner ends of the upper walls 1f and 1g, as bent downwardly, and are substantially parallel with the outer side walls 1d and 1e.

The upper rail 2 is formed by bending right and left ends of a slender metallic thin plate by press working. As shown in FIG. 3, the upper rail 2 includes a top wall 2a, a pair of side walls 2b and 2c, a pair of lower ball-retaining walls 2d and 2e, a pair of second inclined walls 2f and 2g, and a pair of upper ball-retaining walls 2h and 2i. The top wall 2a is mounted to a bottom face of the seat via a fixing member not shown. The side walls 2b and 2c extend from right and left ends of the top wall 2a, as bent downwardly, and are substantially perpendicular to the top wall 2a. The lower ball-retaining walls 2d and 2e extend outwardly from lower ends of the side walls 2b and 2c, as bent into arc shapes. The second inclined walls 2f and 2g extend upwardly from upper ends of the lower ball-retaining walls 2d and 2e, as inclined toward the outer side walls 1d and 1e respectively. The upper ball-retaining walls 2h and 2i extend inwardly from upper ends of the second inclined walls 2f and 2g, as bent into arc shapes.

As shown in FIG. 3, the lower ball-retaining walls 2d and 2e respectively include lower arc surfaces s1 and s2 that are convex upwardly. Lower guide balls 9 and 10 are interposed between the lower arc surfaces s1 and s2 and arc surfaces s5 and s6. The arc surfaces s5 and s6 are formed between the bottom wall 1a and the first inclined walls 1b and 1c of the lower rail 1, and are convex downwardly. The lower guide balls 9 and 10 are rollable. This reduces friction between the lower rail 1 and the upper rail 2, and allows the upper rail 2 to smoothly move with respect to the lower rail 1.

As shown in FIG. 3, the upper ball-retaining walls 2h and 2i respectively include upper arc surfaces s3 and s4 that are convex downwardly. Upper guide balls 11 and 12 are interposed between the upper arc surfaces s3 and s4 and arc surfaces s7 and s8. The arc surfaces s7 and s8 are formed between the outer side walls 1d and 1e and the upper walls 1f and 1g. The upper guide balls 11 and 12 are rollable, and are less in diameter than the lower guide balls 9 and 10. The rolling of the upper guide balls 11 and 12 reduces friction between the lower rail 1 and the upper rail 2, and allows the upper rail 2 to smoothly move with respect to the lower rail 1.

The lower guide balls 9 and 10 and the upper guide balls 11 and 12 are supported by ball retainers 13 and 14 that extend through gaps between the outer side walls 1d and 1e and the second inclined walls 2f and 2g.

As shown in FIGS. 1 and 2, the lower rail 1 includes two pairs of tongue-shaped stoppers 1j in vicinities of front and rear ends of the lower rail 1. The tongue-shaped stoppers 1j are formed by cutting and raising parts of the upper ends of the outer side walls 1d and 1e inwardly with respect to the outer side walls 1d and 1e. The tongue-shaped stoppers 1j engage with the ball retainers 13 and 14, and thereby serve to suppress the lower guide balls 9 and 10 and the upper guide balls 11 and 12 from escaping from an inside of the lower rail 1.

As shown in FIGS. 1 to 3, the bottom wall 1a of the lower rail 1 includes two pairs of tongues 1k positioned inside in the vehicle front-and-rear direction with respect to the two pairs of tongue-shaped stoppers 1j. The tongues 1k are formed by cutting and raising parts of the bottom wall 1a to a side of the outer side walls 1d and 1e. As shown in FIG. 3, right and left ones of tongues 1k are respectively structured to contact with a right-and-left pair of projections 2j of the upper rail 2. The projections 2j are formed in the side walls 2b and 2c, by leaving parts of the lower ends of the side walls 2b and 2c not bent outwardly. Thus, the projections 2j of the upper rail 2 are structured to mechanically collide with the tongues 1k of the lower rail 1, and thereby regulate a stroke range of the upper rail 2 with respect to the lower rail 1.

The screw shaft 3 is made of a metal, is shaped cylindrical, slender, and substantially equal to the upper rail 2 in length, and is disposed between the pair of side walls 2b and 2c of the upper rail 2. As shown in FIG. 1, the screw shaft 3 includes a body 3a, a first small-diameter part 3b, a wheel-fixing part 3c, and a second small-diameter part 3e. The first small-diameter part 3b is formed integrally with a front end of the body 3a, and is less in diameter than the body 3a. The wheel-fixing part 3c is formed integrally with a front end of the first small-diameter part 3b, and is less in diameter than the body 3a and greater in diameter than the first small-diameter part 3b. The second small-diameter part 3e is formed integrally with a rear end of the body 3a, and is less in diameter than the body 3a.

The body 3a includes an outer peripheral surface including an external screw 3f. The external screw 3f is screwed to an internal screw hole 6a of the nut 6. The screwing of the external screw 3f and the internal screw hole 6a causes the screw shaft 3 to move with respect to the nut 6 in the vehicle front-and-rear direction, in response to rotation of the screw shaft 3.

The wheel-fixing part 3c includes an outer peripheral surface including a serration 3g. The serration 3g is fit to a worm wheel not shown disposed in the gearbox 4. The worm wheel engages with a worm shaft not shown fixed to a motor shaft of the electric motor 5, as a component of the gear mechanism. Although FIGS. 1 and 2 exemplify the electric seat slider to be positioned in the left side of the seat, in actuality another one of the electric seat slider except for the electric motor 5 is to be positioned also in the right side of the seat. The electric motor 5 is connected to the gear box of the right-side one of the electric seat sliders via a connector not shown. Accordingly, the electric motor 5 rotates the screw shaft 3 of the left-side one of the electric seat sliders and the screw shaft 3 of the right-side one of the electric seat sliders, synchronizing them.

The second small-diameter part 3e is supported inside a tube 15a of the end cap 15 so as to be rotatable, and is less in diameter than the body 3a of the screw shaft 3 in order to avoid interference with the internal screw hole 6a of the nut 6. The end cap 15 includes a pair of engagement claws 15b integrated with an outer periphery of the tube 15a. The pair of engagement claws 15b engage with a pair of engagement halls 2k formed in the side walls 2b and 2c of the upper rail 2, and thereby fix the end cap 15 to the side walls 2b and 2c.

The upper rail 2 includes a pair of mounting parts 2m in front ends of the side walls 2b and 2c. The mounting parts 2m are parts to which the gearbox 4 is mounted. Each of the mounting parts 2m includes a through hole 2n extending through a corresponding one of the side walls 2b and 2c in a thickness direction thereof. Via these two through holes 2n, the gearbox 4 is mounted to the mounting parts 2m with fixing members (e.g., caulking pins 23 in the present embodiment).

The upper rail 2 is provided with reinforcement plates 16 and 17 mounted to the upper rail 2 in vicinities of the front end and the rear end of the upper rail 2. The reinforcement plate 16 and 17 are substantially rectangular plates similar to each other in shape. The reinforcement plates 16 and 17 are disposed perpendicularly to the top wall 2a of the upper rail 2.

The following describes the reinforcement plate 16 as a representative. The reinforcement plate 16 includes a pair of recessed parts 16a, a pair of expanded parts 16b, a pair of depressed parts 16c, and a projection 16d. The recessed parts 16a are positioned in vicinities of upper ends of the reinforcement plate 16 in right and left ends of the recessed parts 16a, and are recessed inwardly. The expanded parts 16b are positioned lower than the recessed parts 16a in the right and left ends of the recessed parts 16a, and are expanded outwardly. The depressed parts 16c are positioned in a vicinity of a center of a top of the reinforcement plate 16, and are depressed inwardly. The projection 16d is positioned between the pair of depressed parts 16c, and projects upwardly from the top of the reinforcement plate 16. As shown in FIG. 3, the recessed parts 16a engage with cut-and-raised parts 2o that is formed in the side walls 2b and 2c of the upper rail 2 by cutting and raising parts of side walls 2b and 2c inwardly. This suppresses the reinforcement plate 16 from dropping from the upper rail 2. As shown in FIG. 3, the expanded parts 16b are inserted in a pair of slits 2p formed in the side walls 2b and 2c, and the projection 16d is inserted in a hole 2q formed in the top wall 2a of the upper rail 2. As shown in FIG. 1, the reinforcement plate 16 further includes an annular projection 16e projecting from a front surface of the reinforcement plate 16 toward a stopper 18 described below. The annular projection 16e strengthens the reinforcement plate 16 in rigidity so as to suppress the reinforcement plate 16 from being deformed by contact with the stopper 18 in case that the upper rail 2 moves frontward due to collision of the vehicle.

As shown in FIG. 3, the reinforcement plate 16 includes a through hole 16f extending through the reinforcement plate 16 in the vehicle front-and-rear direction. The through hole 16f receives the screw shaft 3 inserted therein. The through hole 16f has an inner diameter greater than an outer diameter of the screw shaft 3. This allows the screw shaft 3 inserted in the through hole 16f to rotate.

The screw shaft 3 is provided with the stopper 18 and a stopper 19. The stopper 18 is positioned in front of the reinforcement plate 16 on the body 3a of the screw shaft 3. The stopper 19 is positioned in rear of the reinforcement plate 17 on the body 3a of the screw shaft 3. Each of the stoppers 18 and 19 is a lock nut including a screw thread partially crushed beforehand, and is screwed to a predetermined position of the body 3a and fixed there. The lock nut including the screw thread partially crushed beforehand may be replaced with a normal nut including a screw thread not crushed. In such case, the normal nut as the stopper is screwed to the predetermined position of the body 3a, and is pressed and calked from outside to inside of the stopper and thereby fixed to the body 3a.

In case that the upper rail 2 receives a collision load directed frontward in the vehicle front-and-rear direction due to vehicle collision etc., the reinforcement plate 16 moves frontward and collides with the stopper 18 positioned in front of the reinforcement plate 16. This suppresses the gearbox 4 mounted to the upper rail 2 from directly receiving the collision load, and thereby suppresses the gearbox 4 from undergoing a collision load that is to separate the gearbox 4 from the screw shaft 3. On this occasion, the screw shaft 3 receives a tractive force.

In case that the upper rail 2 receives a collision load directed rearward in the vehicle front-and-rear direction due to vehicle collision etc., the reinforcement plate 17 moves rearward and collides with the stopper 19 positioned in rear of the reinforcement plate 17. This suppresses the gearbox 4 mounted to the upper rail 2 from directly receiving the collision load, and thereby suppresses the gearbox 4 from pressing the screw shaft 3 due to the collision load. Also on this occasion, the screw shaft 3 receives a tractive force.

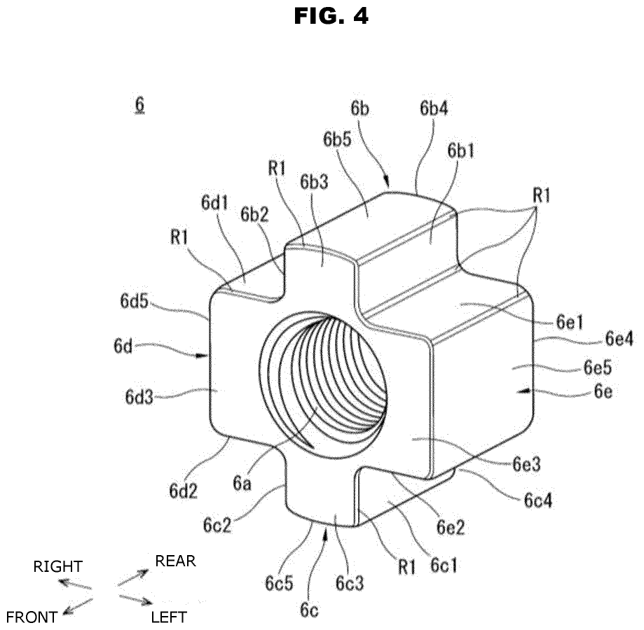

FIG. 4 is an oblique view of the nut 6. In FIG. 4, the vehicle front-and-rear direction corresponds to a right diagonal direction shown by arrows of “FRONT” and “REAR” in the drawing. The vertical direction corresponds to an upper-and-lower direction of the drawing. The right-and-left direction corresponds to a direction shown by arrows of “RIGHT” and “LEFT” in the drawing.

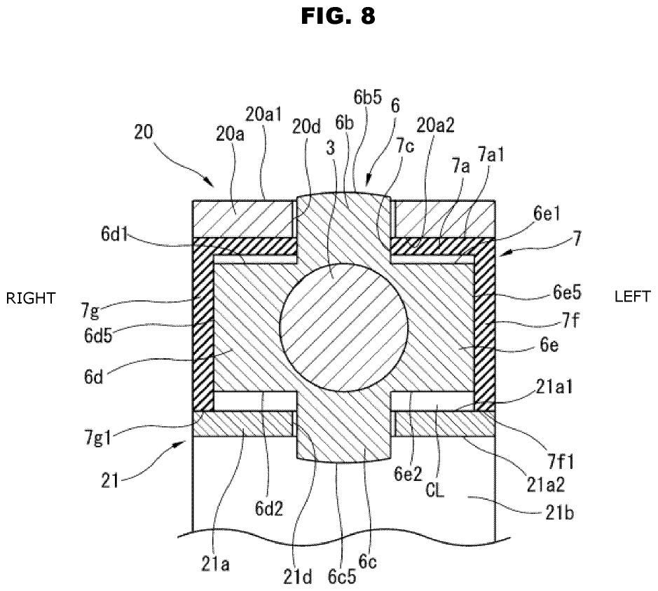

The nut 6 is produced by: deforming an outer periphery of a metallic rectangular-pole block by press working; and forming the internal screw hole 6a extending in the vehicle front-and-rear direction, at a center of the nut 6 in the vertical direction and the right-and-left direction. The shape of the block before press working is not limited to the rectangular pole, but may be another shape such as a circular column. As shown in FIGS. 1 and 4, the nut 6 has a shape of a cross symmetrical in the vertical direction and symmetrical in the right-and-left direction when viewed from the vehicle front-and-rear direction. The cross shape of the nut 6 in the present embodiment is formed by crossing of a first part and a second part, wherein the first part and the second part is respectively a part of the nut 6 continuous in the vertical direction and a part of the nut 6 continuous in the right-and-left direction in case of supposing that the internal screw hole 6a of the nut 6 is absent and is filled up with the metallic material. Furthermore, the nut 6 is shaped symmetrical also in the vehicle front-and-rear direction, i.e., the cross shape of the nut 6 continues in the vehicle front-and-rear direction. This naturally results in that a section of the nut 6 in a direction perpendicular to the vehicle front-and-rear direction (e.g., the vertical direction or the right-and-direction) has the cross shape (see FIG. 8).

As shown in FIGS. 1 and 4, the nut 6 includes the internal screw hole 6a, an upper projection 6b, a lower projection 6c, a right projection 6d, and a left projection 6e. The upper projection 6b projects upward from a side over the internal screw hole 6a. The lower projection 6c projects downward from a side under the internal screw hole 6a. The right projection 6d projects rightward from a side on the right (i.e., the left in FIG. 4) of the internal screw hole 6a. The left projection 6e projects leftward from a side on the left (i.e., the right in FIG. 4) of the internal screw hole 6a. The upper projection 6b and the lower projection 6c are shaped similarly to each other. The right projection 6d and the left projection 6e are shaped similarly to each other.

The upper projection 6b includes a left surface 6b1, a right surface 6b2, a front surface 6b3, a rear surface 6b4, and an arc upper surface 6b5. The left surface 6b1 is exposed leftward, and has a rectangular shape with a long side extending in the vehicle front-and-rear direction. The right surface 6b2 is exposed rightward, and has a rectangular shape with a long side extending in the vehicle front-and-rear direction. The front surface 6b3 is exposed frontward, and has a substantially rectangular shape. The rear surface 6b4 is exposed rearward, and has a substantially rectangular shape. The arc upper surface 6b5 is exposed upward, and has a shape of an arc convex upward when viewed from the vehicle front-and-rear direction.

The lower projection 6c includes a left surface 6c1, a right surface 6c2, a front surface 6c3, a rear surface 6c4, and an arc lower surface 6c5. The left surface 6c1 is exposed leftward, and has a rectangular shape with a long side extending in the vehicle front-and-rear direction. The right surface 6c2 is exposed rightward, and has a rectangular shape with a long side extending in the vehicle front-and-rear direction. The front surface 6c3 is exposed frontward, and has a substantially rectangular shape. The rear surface 6c4 is exposed rearward, and has a substantially rectangular shape. The arc lower surface 6c5 is exposed downward, and has a shape of an arc convex downward when viewed from the vehicle front-and-rear

The right projection 6d includes an upper surface 6d1, a lower surface 6d2, a front surface 6d3, a rear surface 6d4, and a right surface 6d5. The upper surface 6d1 is exposed upward, and has a rectangular shape with a long side extending in the vehicle front-and-rear direction. The lower surface 6d2 is exposed downward, and has a rectangular shape with a long side extending in the vehicle front-and-rear direction. The front surface 6d3 is exposed frontward, and has a substantially rectangular shape with a long side extending in the vertical direction. The rear surface 6d4 is exposed rearward, and has a substantially rectangular shape with a long side extending in the vertical direction (see FIG. 1). The right surface 6d5 is exposed rightward, and has a rectangular shape (see FIG. 8).

The left projection 6e includes an upper surface 6e1, a lower surface 6e2, a front surface 6e3, a rear surface 6e4, and a left surface 6e5. The upper surface 6e1 is exposed upward, and has a rectangular shape with a long side extending in the vehicle front-and-rear direction. The lower surface 6e2 is exposed downward, and has a rectangular shape with a long side extending in the vehicle front-and-rear direction. The front surface 6e3 is exposed frontward, and has a substantially rectangular shape with a long side extending in the vertical direction. The rear surface 6e4 is exposed rearward, and has a substantially rectangular shape with a long side extending in the vertical direction. The left surface 6e5 is exposed leftward, and has a rectangular shape.

As shown in FIG. 4, each pair of adjacent surfaces of the nut 6 are smoothly connected via a round part R1 due to a shape of a mold for the press working.

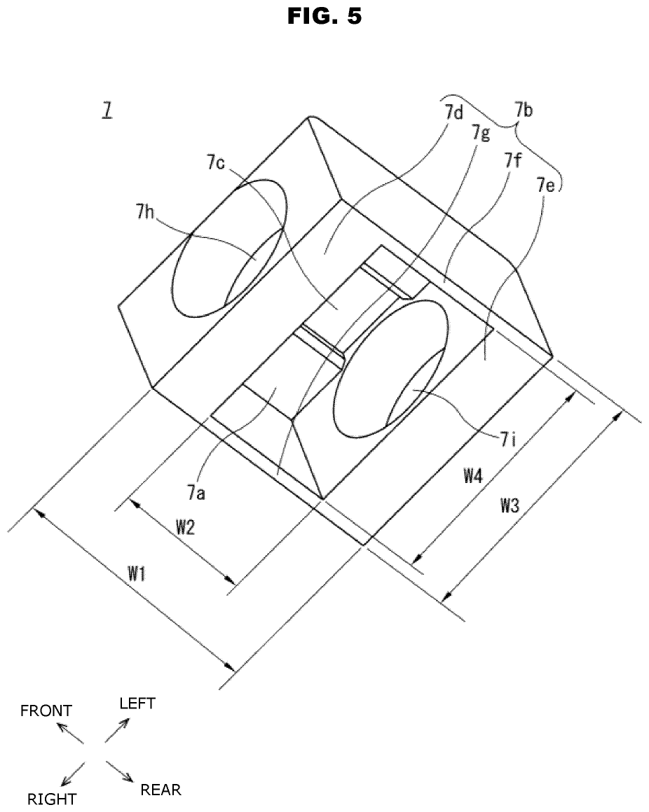

FIG. 5 is an oblique view of the elastic member 7. In FIG. 5, the vehicle front-and-rear direction corresponds to a direction of a thickness of a front wall 7d described below. The vertical direction corresponds to a direction of a thickness of a ceiling wall 7a described below. The right-and-left direction corresponds to a direction of a thickness of a left wall 7f described below.

The elastic member 7 has a shape of a rectangular box including a lower face including an opening, by molding an elastically deformable material such as a rubber. The elastic member 7 is installed in the bracket 8, and retains the nut 6 while allowing the nut 6 to move in the vertical direction.

The elastic member 7 includes a ceiling wall 7a and a rectangular tubular wall 7b. The ceiling wall 7a has a shape of a rectangular plate. The rectangular tubular wall 7b has a shape of a rectangular tube extending in the vertical direction from a rim of the ceiling wall 7a.

The ceiling wall 7a includes a ceiling wall rectangular hole 7c extending through the ceiling wall 7a in the vertical direction. The ceiling wall rectangular hole 7c has a rectangular shape with a long side extending in the vehicle front-and-rear direction. The rectangular shape of the ceiling wall rectangular hole 7c is substantially equal in size to a rectangular shape of the arc upper surface 6b5 of the upper projection 6b when viewing the nut 6 from the upper side. The ceiling wall rectangular hole 7c accepts the upper projection 6b inserted therein. The ceiling wall rectangular hole 7c has a depth in the vertical direction smaller than a height of the upper projection 6b in the vertical direction.

The rectangular tubular wall 7b includes a front wall 7d, a rear wall 7e, a left wall 7f, and a right wall 7g. The front wall 7d extends in the vertical direction from a front rim of the ceiling wall 7a. The rear wall 7e extends in the vertical direction from a rear rim of the ceiling wall 7a, and is opposite to the front wall 7d. The left wall 7f extends in the vertical direction from a left rim of the ceiling wall 7a. The right wall 7g extends in the vertical direction from a right rim of the ceiling wall 7a, and is opposite to the left wall 7f. The front wall 7d and the rear wall 7e are shaped rectangular similarly to each other. The left wall 7f and the right wall 7g are shaped rectangular similarly to each other. The thickness of the front wall 7d and the rear wall 7e in the vehicle front-and-rear direction is greater than the thickness of the left wall 7f and the right wall 7g in the right-and-left direction. Furthermore, the thickness of the front wall 7d and the rear wall 7e in the vehicle front-and-rear direction is greater than a thickness of the ceiling wall 7a in the vertical direction. The front wall 7d includes a first damper through

hole 7h having a circular shape and extending through the front wall 7d in the vehicle front-and-rear direction. When viewed from the vehicle front-and-rear direction, the first damper through hole 7h overlaps with the internal screw hole 6a that extends through the nut 6 in the vehicle front-and-rear direction. The first damper through hole 7h has an inner diameter greater than an outer diameter of the screw shaft 3, and accepts the screw shaft 3 inserted in the first damper through hole 7h.

The rear wall 7e includes a second damper through hole 7i having a circular shape similar to the first damper through hole 7h and extending through the rear wall 7e in the vehicle front-and-rear direction. When viewed from the vehicle front-and-rear direction, the second damper through hole 7i overlaps with the internal screw hole 6a that extends through the nut 6 in the vehicle front-and-rear direction. The second damper through hole 7i has an inner diameter greater than an outer diameter of the screw shaft 3, and accepts the screw shaft 3 inserted in the second damper through hole 7i.

The elastic member 7 has a width W1 in the vehicle front-and-rear direction set to a value that allows the elastic member 7 to be press-fitted in a gap between a pair of first walls 20b of a first bracket 20 described below of the bracket 8.

A width W2 between the front wall 7d and the rear wall 7e in the vehicle front-and-rear direction is equal to a width of the ceiling wall rectangular hole 7c in the vehicle front-and-rear direction, and corresponds to a width of the nut 6 in the vehicle front-and-rear direction (e.g., a width from the front surface 6e3 to the rear surface 6e4 of the left projection 6e).

A width W3 of the rectangular tubular wall 7b in the right-and-left direction corresponds to a width of a first upper wall 20a of the first bracket 20 described below of the bracket 8 in the right-and-left direction (see FIG. 8). A width W4 between the left wall 7f and the right wall 7g in the right-and-left direction corresponds to a width of the nut 6 in the right-and-left direction (i.e., a width from the right surface 6d5 of the right projection 6d to the left surface 6e5 of the left projection 6e).

The following describes the bracket 8, with reference to FIG. 1 again.

The bracket 8 retains the elastic member 7 retaining the nut 6, and fixes the elastic member 7 to a position in front of a center of the bottom wall 1a of the lower rail 1 in the vehicle front-and-rear direction. The bracket 8 includes a first bracket 20 and a second bracket 21 disposed under the first bracket 20.

The first bracket 20 is formed by bending a metallic plate by press working, and includes a first upper wall 20a, a pair of first walls 20b, and a pair of first mounting walls 20c. The first walls 20b extend from ends in the vehicle front-and-rear direction of the first upper wall 20a, as bent downwardly, and are perpendicular to the first upper wall 20a. The first mounting walls 20c extend from lower ends of the first walls 20b, as bent in the vehicle front-and-rear direction, so as to going away from each other. Each of the first walls 20b is connected to the first upper wall 20a via a round part R2 formed due to bending of the metallic plate. Similarly, each of the first mounting walls 20c is connected to a corresponding one of the first walls 20b via a round part R3 formed due to bending of the metallic plate.

The first upper wall 20a includes at its center a first rectangular hole 20d extending through the first upper wall 20a in the vertical direction. The first rectangular hole 20d has a rectangular shape with a long side extending in the vehicle front-and-rear direction, and accepts the upper projection 6b of the nut 6 inserted in the first rectangular hole 20d. The first rectangular hole 20d includes a front end surface 20d1 and a rear end surface 20d2 positioned in rear of the front end surface 20d1 in the vehicle front-and-rear direction.

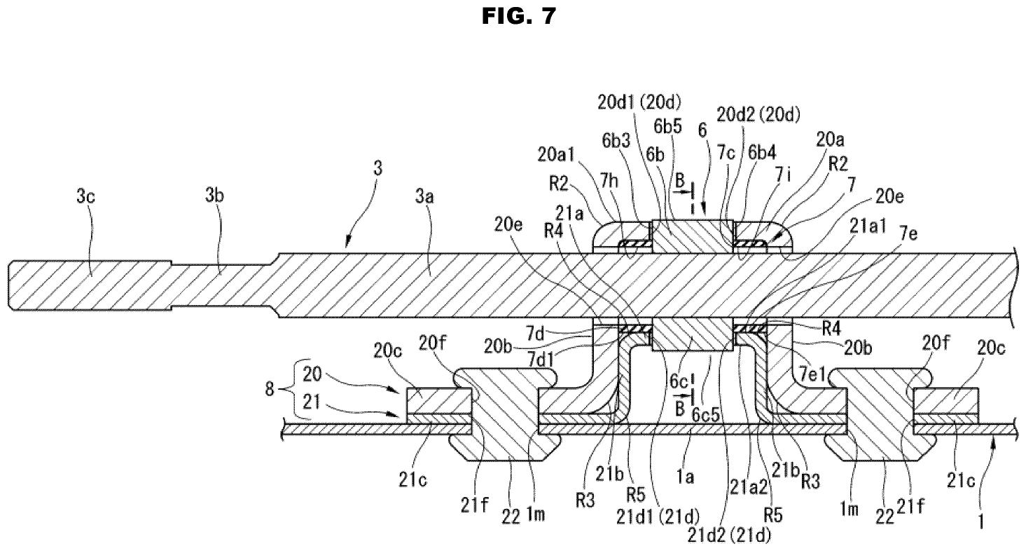

Each of the pair of the first walls 20b includes an insertion hole 20e extending through the each of the first walls 20b in the vehicle front-and-rear direction. Each of the insertion holes 20e has a shape elongated in the vertical direction, is positioned nearer to the round part R2 than to the other end in the first walls 20b, and has an inner diameter greater than the outer diameter of the screw shaft 3 so as to accept the screw shaft 3 inserted in the each of the insertion holes 20e. As shown in FIG. 7, the hole vertical diameter of each of the insertion holes 20e is substantially equal to the circular hole diameters of the first damper through hole 7h and the second damper through hole 7i.

Each of the pair of first mounting walls 20c includes a first mounting hole 20f extending through the each of the pair of first mounting walls 20c in the vertical direction. Each of the first mounting holes 20f accepts a fastener 22 inserted in the each of the first mounting holes 20f upon mounting the first bracket 20 and the second bracket 21 to the lower rail 1.

The second bracket 21 is formed by bending a metallic plate less in thickness than the first bracket 20, and includes a second upper wall 21a, a pair of second walls 21b, and a pair of second mounting walls 21c. The second walls 21b extend from ends in the vehicle front-and-rear direction of the second upper wall 21a, as bent downwardly, and are perpendicular to the second upper wall 21a. The second mounting walls 21c extend from lower ends of the second walls 21b, as bent in the vehicle front-and-rear direction, so as to going away from each other. Each of the second walls 21b is connected to the second upper wall 21a via a round part R4 formed due to bending of the metallic plate. Similarly, each of the second mounting walls 21c is connected to a corresponding one of the second walls 21b via a round part R5 formed due to bending of the metallic plate.

The second upper wall 21a includes at its center a second rectangular hole 21d extending through the second upper wall 21a in the vertical direction. The second rectangular hole 21d has a rectangular shape with a long side extending in the vehicle front-and-rear direction. The second rectangular hole 21d is shaped similarly to the first rectangular hole 20d of the first upper wall 20a of the first bracket 20, and the rectangular shape of the second rectangular hole 21d is equal to the rectangular shape of the first rectangular hole 20d in length in the vehicle front-and-rear direction and in width in the right-and-left direction. Furthermore, the second rectangular hole 21d is same with the first rectangular hole 20d in position in the vehicle front-and-rear direction. The second rectangular hole 21d accepts the lower projection 6c of the nut 6 inserted in the second rectangular hole 21d. The second rectangular hole 21d includes a front end surface 21d1 and a rear end surface 21d2 positioned in rear of the front end surface 21d1 in the vehicle front-and-rear direction.

Each of the pair of second mounting walls 21c includes a second mounting hole 21f extending through the each of the pair of second mounting walls 21c in the vertical direction. Each of the second mounting holes 21f accepts a fastener 22 inserted in the each of the second mounting holes 21f upon mounting the first bracket 20 and the second bracket 21 to the lower rail 1.

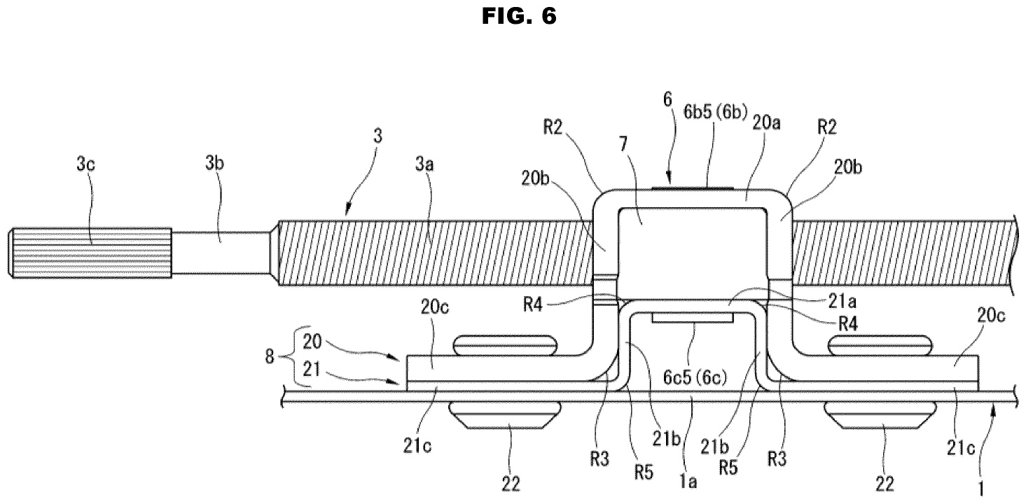

FIG. 6 is a side view showing how the nut 6 is installed in the seat slider according to the present embodiment. FIG. 7 is a longitudinal sectional view in the vehicle front-and-rear direction corresponding to FIG. 6, which shows how the nut 6 is installed. FIG. 8 is a cross sectional view along a line B-B shown in FIG. 7, which shows how the nut 6 is installed. In FIG. 8, the round parts R1 are omitted for simplicity and clarity of the drawing.

The following describes an installation structure of the nut 6 in the lower rail 1.

As shown in FIGS. 6 and 7, the nut 6 is mounted to the bottom wall 1a of the lower rail 1 via the first bracket 20 and the second bracket 21. The elastic member 7 is interposed between the nut 6 and the first and second brackets 20 and 21. The nut 6 is press-fitted (in detail, light press-fitting that can be easily performed by hand) inside the elastic member 7 (in detail, inside the rectangular tubular wall 7b as described above), so as to exclude a gap extending in the vehicle front-and-rear direction and a gap extending in the right-and-left direction. Although the nut 6 is in press contact with the elastic member 7 without the gap extending in the vehicle front-and-rear direction or the gap extending in the right-and-left direction, this press contact is set to an extent to allow the nut 6 to move in the vehicle front-and-rear direction and the right-and-left direction. As shown in FIG. 8, the ceiling wall 7a of the elastic member 7 includes an upper surface 7a1 that is in close contact with a lower surface 20a2 of the first upper wall 20a of the first bracket 20. In addition, as shown in FIGS. 7 and 8, the front wall 7d, the rear wall 7e, the left wall 7f, and the right wall 7g of the elastic member 7 respectively include lower surfaces 7d1, 7e1, 7f1, and 7g1 that are in close contact with an upper surface 21a1 of the second upper wall 21a of the second bracket 21.

The ceiling wall 7a of the elastic member 7 covers the upper surfaces of the nut 6, i.e., the upper surface 6d1 of the right projection 6d and the upper surface 6e1 of the left projection 6e in the present embodiment.

The rectangular tubular wall 7b of the elastic member 7 covers four surfaces (right, left, front, and rear surfaces) of the nut 6. In detail, as shown in FIG. 8, the left wall 7f and the right wall 7g of the rectangular tubular wall 7b cover the right and left surfaces of the nut 6, i.e., the left surface 6e5 and the left projection 6e and the right surface 6d5 of the right projection 6d in the present embodiment. The front wall 7d and the rear wall 7e of the rectangular tubular wall 7b cover the front and rear surfaces, i.e., the front surface 6d3 of the right projection 6d, the front surface 6e3 of the left projection 6e, the rear surface 6d4 of the right projection 6d, and the rear surface 6e4 of the left projection 6e in the present embodiment.

As shown in FIG. 8, the upper surface 21a1 of the second upper wall 21a of the second bracket 21 and each of the lower surfaces of the nut 6 except for the lower projection 6c (i.e., the lower surface 6d2 of the right projection 6d and the lower surface 6e2 in the present embodiment) has a clearance CL therebetween in the vertical direction. Through the clearances CL, the nut 6 is movable in the vertical direction between the first upper wall 20a of the first bracket 20 and the second upper wall 21a of the second bracket 21. In a state in which the nut 6 is installed, the upper projection 6b of the nut 6 extends through the ceiling wall rectangular hole 7c of the ceiling wall 7a and the first rectangular hole 20d of the first upper wall 20a. As shown in FIGS. 7 and 8, the upper projection 6b does not escape from the first rectangular hole 20d, even in case that the nut 6 moves downward and the lower surfaces 6d2 and 6e2 (i.e., the lower surfaces of the nut 6 except for the lower projection 6c) contact with the second upper wall 21a of the second bracket 21. Similarly, the lower projection 6c does not escape from the second rectangular hole 21d, even in case that the nut 6 moves upward and the upper surfaces 6d1 and 6e2 (i.e., the upper surfaces of the nut 6 except for the upper projection 6b) contact with the ceiling wall 7a of the elastic member 7 to compress the ceiling wall 7a. These are achieved by setting of the clearances and setting of vertical heights of the upper projection 6b and the lower projection 6c.

As shown in FIG. 8, the upper projection 6b and the lower projection 6c do not respectively escape from the first rectangular hole 20d and the second rectangular hole 21d through them, while the right projection 6d and the left projection 6e travel a distance of the clearances CL in the vertical direction between the first upper wall 20a of the first bracket 20 and the second upper wall 21a of the second bracket 21. Thus, the upper projection 6b and the lower projection 6c are sufficient in vertical height to prevent the upper projection 6b and the lower projection 6c from escaping from the first rectangular hole 20d of the first bracket 20 or the second rectangular hole 21d of the second bracket 21.

The upper projection 6b, which extends through the first rectangular hole 20d, and each of the front end surface 20d1 and the rear end surface 20d2 of the first rectangular hole 20d have a slight gap therebetween. Preferably, the gaps are designed narrow within an extent to allow easy insertion (i.e., insertion that is not press-fitting) of the upper projection 6b into the first rectangular hole 20d even in case of dispersion in dimension of the upper projection 6b and/or the first rectangular hole 20d. For example, in case of mechanically colliding the front-side ones of the projections 2j (see FIG. 3) of the upper rail 2 with the front-side ones of the tongues 1k of the lower rail 1 and thereby regulating the stroke range of the upper rail 2 with respect to the lower rail 1, the front surface 6b3 of the upper projection 6b compress and deform the front wall 7d of the elastic member 7. This deformation of the elastic member 7 gradually narrows the gap between the front surface 6b3 of the upper projection 6b and the front end surface 20d1 of the first rectangular hole 20d, and eventually causes the front surface 6b3 of the upper projection 6b to contact with the front end surface 20d1 of the first rectangular hole 20d. This stops the deformation of the elastic member 7. In case of mechanically colliding the rear-side ones of the projections 2j of the upper rail 2 with the rear-side ones of the tongues 1k of the lower rail 1, the gap between the rear surface 6b4 of the upper projection 6b and the rear end surface 20d2 of the first rectangular hole 20d gradually narrows, and then the rear surface 6b4 of the upper projection 6b contacts with the rear end surface 20d2 of the first rectangular hole 20d. Thus, the designing of the gaps to be narrow serves to reduce an amount of displacement of the nut 6 in the vehicle front-and-rear direction.

The first bracket 20 and the second bracket 21 cover four faces (i.e., upper, lower, front, and rear faces) of the nut 6 from outside of the elastic member 7. In detail, as shown in FIG. 8, the first upper wall 20a of the first bracket 20 and the second upper wall 21a of the second bracket 21 cover the upper and lower faces of the nut 6 (i.e., the upper surface 6d1 of the right projection 6d, the upper surface 6e1 of the left projection 6e, the lower surface 6d2 of the right projection 6d, and the lower surface 6e2 of the left projection 6e in the present embodiment) from outside of the elastic member 7. The pair of first walls 20b of the first bracket 20 cover the front and rear faces of the nut 6 (i.e., the front surface 6d3 of the right projection 6d, the front surface 6e3 of the left projection 6e, the rear surface 6d4 of the right projection 6d, the rear surface 6d4 of the right projection 6d, and the rear surface 6e4 of the left projection 6e) from outside of the elastic member 7.

The elastic member 7 has a length in the vehicle front-and-rear direction that corresponds to a sum of a length of the second upper wall 21a of the second bracket 21 in the vehicle front-and-rear direction and lengths of two of the round parts R4 (i.e., parts formed by bending the metallic plate) in the vehicle front-and-rear direction. The sum is equal to a length between an outer surfaces of the pair of second walls 21b of the second bracket 21 in the vehicle front-and-rear direction.

Each of the pair of second walls 21b faces a corresponding one of the pair of first walls 20b of the first bracket 20.

The pair of second mounting walls 21c of the second bracket 21 faces a corresponding one of the pair of first mounting walls 20c of the first bracket 20. As shown in FIG. 7, each facing pair out of the second mounting holes 21f of the second mounting walls 21c and the first mounting holes 20f of the first mounting walls 20c are aligned with each other in the vertical direction, and aligned with a corresponding one of rail-side mounting holes 1m formed in the bottom wall 1a of the lower rail 1. The fasteners 22 are inserted in the first mounting holes 20f, the second mounting holes 21f, and the rail-side mounting holes 1m, and are caulked. Thus, the first mounting walls 20c and the second mounting walls 21c overlapping with each other are mounted to the bottom wall 1a of the lower rail 1.

As described above, the nut 6 has the shape of the cross through an entire outline thereof, when viewed at a section perpendicular to the front-and-rear direction. The cross shape of the nut 6 is formed by combination of: the upper projection 6b and the lower projection 6c symmetrical in the vertical direction across the internal screw hole 6a; and the right projection 6d and the left projection 6e symmetrical in the right-and-left direction across the internal screw hole 6a. The outline of the cross shape is relatively easily formed by, for example, merely deforming an outer periphery of a rectangular-pole block by press working. This serves to simplify the shape of the nut 6, improve workability of the nut 6, and reduce a manufacturing cost of the nut 6, in comparison with a case of forming a projection on a surface of the nut 6 facing the first bracket 20.

According to the present embodiment, the elastic member 7 is shaped as the rectangular box including: the ceiling wall 7a covering the upper face of the nut 6; and the rectangular tubular wall 7b extending from the rim of the ceiling wall 7a and covering the four faces (i.e., the right, left, upper, and lower faces) of the nut 6. The ceiling wall 7a includes the ceiling wall rectangular hole 7c. The front wall 7d and the rear wall 7e of the rectangular tubular wall 7b respectively include the first damper through hole 7h and the second damper through hole 7i. Thus, the elastic member 7 is produced by merely shaping a rectangular box being relatively simple and forming in it three holes, i.e., the ceiling wall rectangular hole 7c, the first damper through hole 7h, and the second damper through hole 7i, by molding with employment of a rubber material. This serves to simplify the shape of the nut 6, improve the workability of the nut 6, and reduce the manufacturing cost of the nut 6. Furthermore, the above also facilitates installation of the nut 6 to the elastic member 7 because of allowing the nut 6 to be installed by merely inserting the nut 6 into the elastic member 7 having the simple rectangular box shape via the opening of the rectangular tubular wall 7b.

According to the present embodiment, the nut 6 is allowed to move in the vertical direction with respect to the elastic member 7 providing elastic force. The nut 6 moves in the vertical direction so as to align an axis of the internal screw hole 6a of the nut 6 with an axis of the screw shaft 3. This suppresses noise and vibration caused due to rotation of the screw shaft 3.

The upper projection 6b extends through the first rectangular hole 20d of the first upper wall 20a of the first bracket 20, and the lower projection 6c extends through the second rectangular hole 21d of the second upper wall 21a of the second bracket 21. This causes the upper projection 6b to contact with the front end surface 20d1 and the rear end surface 20d2 of the first rectangular hole 20d and causes the lower projection 6c to contact with the front end surface 21d1 and the rear end surface 21d2 of the second rectangular hole 21d, in case that the screw shaft 3 continues rotating after the upper rail 2 collides with the lower rail 1 and stops. This suppresses excessive compression of the elastic member 7 and suppresses biting of the screw shaft 3 into the elastic member 7, and thereby reduces a force required for reverse operation of the screw shaft 3 and reduces noise and vibration.

As described above, the present embodiment serves to simplify the nut 6 and the elastic member 7 in shape and improve them in workability, without deteriorating a function for adjustment of the axis of the screw shaft 3 and the axis of the internal screw hole 6a of the nut 6.

According to the present embodiment, the cross shape of the nut 6 is symmetrical in the vertical direction and in the vehicle front-and-rear direction, and the first rectangular hole 20d of the first bracket 20 and the second rectangular hole 21d of the second bracket 21 are equal to each other in length in the vehicle front-and-rear direction and same with each other in position in the vehicle front-and-rear direction. Accordingly, the upper projection 6b and the lower projection 6c of the nut 6 are same with each other in shape. This allows the lower projection 6c and the upper projection 6b to respectively contact the first rectangular hole 20d and the second rectangular hole 21d appropriately even in case of inserting the lower projection 6c in the first rectangular hole 20d and inserting the upper projection 6b in the second rectangular hole 21d. This eliminates wrong installation of the nut 6 to the first bracket 20 and the second bracket 21.

Furthermore, the present embodiment allows installation of the nut 6 to be performed by inserting the upper projection 6b and the lower projection 6c into the first rectangular hole 20d and the second rectangular hole 21d, and thereby eliminates necessity for strict position determination of the nut 6 with respect to the first bracket 20 and the second bracket 21. This facilitates insertion operation of the nut 6.

According to the present embodiment, the nut 6 is inserted in the rectangular tubular wall 7b so as to form no gap extending in the vehicle front-and-rear direction and no gap extending in the right-and-left direction. This causes the elastic member 7 to moderately retain the nut 6, and thereby suppresses rattling of the nut 6 with respect to the elastic member 7 and normal vibration of the nut 6.

The upper projection 6b is disposed inside the first rectangular hole 20d such that the upper projection 6b and each of the front end surface 20d1 and the rear end surface 20d2 of the first rectangular hole 20d have the gap therebetween. Similarly, the lower projection 6c is disposed inside the second rectangular hole 21d such that the lower projection 6c and the each of the front end surface 21d1 and the rear end surface 21d2 of the second rectangular hole 21d have the gap therebetween. In case of mechanically colliding the upper rail 2 with the lower rail 1 to cause the upper projection 6b to contact the front end surface 20d1 of the first rectangular hole 20d, the front wall 7d of the elastic member 7 is compressed until the gap between the upper projection 6b and the front end surface 20d1 is eliminated. Thus, excessive compression of the elastic member 7 can be suppressed by appropriately setting dimensions of the gaps.

According to the present embodiment, the clearances CL are formed between the right projection 6d and the left projection 6e and the first upper wall 20a of the first bracket 20 (i.e., the ceiling wall 7a of the elastic member 7) and the upper surface 21a1 of the second upper wall 21a of the second bracket 21. The nut 6 is movable in the vertical direction between the first upper wall 20a of the first bracket 20 and the second upper wall 21a of the second bracket 21. Thus, the nut 6 is set to movable in the vertical direction without compressing the elastic member 7, within a range corresponding to the vertical length of the clearances CL. The clearances CL absorb vertical dispersion of the lower rail 1 and the upper rail 2 caused due to assembly error etc. Accordingly, the vertical move of the nut 6 through the clearances CL aligns the axis of the screw shaft 3 and the axis of the internal screw hole 6a of the nut 6. This suppresses noise and vibration caused due to rotation of the screw shaft 3.

The present embodiment exemplifies a case of rotatably mounting the screw shaft 3 to the upper rail 2. However, the present invention is not limited to that. The screw shaft 3 may be rotatably mounted to not the upper rail 2 but the lower rail 1.

The present embodiment exemplifies a case of mounting the nut 6 to the lower rail 1 via the elastic member 7 and the bracket 8. However, the present invention is no limited to that. The nut 6 may be mounted to not the lower rail 1 but the upper rail 2 via the elastic member 7 and the bracket 8.

The following summarizes features of the embodiment of the present disclosure.

According to one aspect of the present disclosure, a seat slider for a vehicle includes: a lower rail extending in a front-and-rear direction of the vehicle; an upper rail structured to be movable in a longitudinal direction of the lower rail relatively with respect to the lower rail; a screw shaft that is mounted to a first one of the lower rail and the upper rail so as to be rotatable, and extends in the longitudinal direction of the lower rail; a nut that is mounted to a second one of the lower rail and the upper rail, includes a screw hole extending through the nut in the front-and-rear direction, and is screwed to the screw shaft; an elastic member having a rectangular box shape and including: a ceiling wall covering an upper face of the nut and including a ceiling wall rectangular hole; a rectangular tubular wall extending from a rim of the ceiling wall and covering front, rear, right, and left faces of the nut; and a through hole overlapping with the screw hole of the nut in the front-and-rear direction; and a bracket supporting the elastic member so as to cover the front face, the rear face, the upper face, and a lower face of the nut from outside of the elastic member. The bracket includes a first bracket and a second bracket. The first bracket includes: a first upper wall facing the upper face of the nut and including a first rectangular hole; a pair of first walls extending downwardly from ends in the front-and-rear direction of the first upper wall and respectively facing the front face and the rear face of the nut; and a pair of first mounting walls extending in the front-and-rear direction from lower ends of the pair of first walls so as to extend away from each other. The second bracket includes: a second upper wall facing the lower face of the nut and including a second rectangular hole; a pair of second walls extending downwardly from ends in the front-and-rear direction of the second upper wall and respectively facing the pair of first walls of the first bracket; and a pair of second mounting walls that extend in the front-and-rear direction from lower ends of the pair of second walls so as to extend away from each other, and are mounted to a bottom wall of the lower rail together with the pair of first mounting walls of the first bracket. The nut has a shape of a cross when viewed at a section perpendicular to a direction of an axis of the screw shaft, and includes: an upper projection extending through the ceiling wall rectangular hole of the ceiling wall of the elastic member and through the first rectangular hole of the first upper wall of the first bracket; and a lower projection projecting downwardly via an open face of the elastic member and extending through the second rectangular hole of the second upper wall of the second bracket.

In addition to the above one aspect of the present disclosure, the nut is shaped symmetrical in the front-and-rear direction and symmetrical in a vertical direction. The first rectangular hole of the first bracket and the second rectangular hole of the second bracket are equal to each other in length in the front-and-rear direction, and are same with each other in position in the front-and-rear

In addition to the above one aspect of the present disclosure, the nut is inserted in the rectangular tubular wall of the elastic member without a gap extending in the front-and-rear direction or a gap extending in a right-and-left direction. Each of the first rectangular hole of the first bracket and the second rectangular hole of the second bracket includes a front end surface and a rear end surface that are respectively positioned in a front side and a rear side in the front-and-rear direction. The upper projection of the nut is disposed inside the first rectangular hole so as to form a gap between the upper projection and the front end surface of the first rectangular hole and a gap between the upper projection and the rear end surface of the first rectangular hole. The lower projection of the nut is disposed inside the second rectangular hole so as to form a gap between the lower projection and the front end surface of the second rectangular hole and a gap between the lower projection and the rear end surface of the second rectangular hole.

In addition to the above one aspect of the present disclosure, the upper face of the nut except for the upper projection and the lower face of the nut except for the lower projection have a distance therebetween that is less than a distance between a lower surface of the ceiling wall of the elastic member and an upper surface of the second upper wall of the second bracket, wherein the ceiling wall of the elastic member is disposed under the first upper wall of the first bracket. The nut is movable in a vertical direction between the ceiling wall of the elastic member and the second upper wall of the second bracket. The upper projection and the lower projection of the nut have heights set to prevent the upper projection and the lower projection from escaping from the first rectangular hole of the first bracket and the second rectangular hole of the second bracket even in case of the vertical move of the nut.

The entire contents of Japanese Patent Application 2023-200397 filed on Nov. 28, 2023 is incorporated herein by reference.

1. A seat slider for a vehicle, the seat slider comprising:
a lower rail extending in a front-and-rear direction of the vehicle;
an upper rail structured to be movable in a longitudinal direction of the lower rail relatively with respect to the lower rail;
a screw shaft that is mounted to a first one of the lower rail and the upper rail so as to be rotatable, and extends in the longitudinal direction of the lower rail;
a nut that is mounted to a second one of the lower rail and the upper rail, includes a screw hole extending through the nut in the front-and-rear direction, and is screwed to the screw shaft;
an elastic member having a rectangular box shape and including: a ceiling wall covering an upper face of the nut and including a ceiling wall rectangular hole; a rectangular tubular wall extending from a rim of the ceiling wall and covering front, rear, right, and left faces of the nut; and a through hole overlapping with the screw hole of the nut in the front-and-rear direction; and
a bracket supporting the elastic member so as to cover the front face, the rear face, the upper face, and a lower face of the nut from outside of the elastic member,
wherein:
the bracket includes a first bracket and a second bracket;
the first bracket includes: a first upper wall facing the upper face of the nut and including a first rectangular hole; a pair of first walls extending downwardly from ends in the front-and-rear direction of the first upper wall and respectively facing the front face and the rear face of the nut; and a pair of first mounting walls extending in the front-and-rear direction from lower ends of the pair of first walls so as to extend away from each other;
the second bracket includes: a second upper wall facing the lower face of the nut and including a second rectangular hole; a pair of second walls extending downwardly from ends in the front-and-rear direction of the second upper wall and respectively facing the pair of first walls of the first bracket; and a pair of second mounting walls that extend in the front-and-rear direction from lower ends of the pair of second walls so as to extend away from each other, and are mounted to a bottom wall of the lower rail together with the pair of first mounting walls of the first bracket; and
the nut has a shape of a cross when viewed at a section perpendicular to a direction of an axis of the screw shaft, and includes: an upper projection extending through the ceiling wall rectangular hole of the ceiling wall of the elastic member and through the first rectangular hole of the first upper wall of the first bracket; and a lower projection projecting downwardly via an open face of the elastic member and extending through the second rectangular hole of the second upper wall of the second bracket.

2. The seat slider as claimed in claim 1, wherein:
the nut is shaped symmetrical in the front-and-rear direction and symmetrical in a vertical direction; and
the first rectangular hole of the first bracket and the second rectangular hole of the second bracket are equal to each other in length in the front-and-rear direction, and are same with each other in position in the front-and-rear direction.

3. The seat slider as claimed in claim 1, wherein:
the nut is inserted in the rectangular tubular wall of the elastic member without a gap extending in the front-and-rear direction or a gap extending in a right-and-left direction;
each of the first rectangular hole of the first bracket and the second rectangular hole of the second bracket includes a front end surface and a rear end surface that are respectively positioned in a front side and a rear side in the front-and-rear direction;
the upper projection of the nut is disposed inside the first rectangular hole so as to form a gap between the upper projection and the front end surface of the first rectangular hole and a gap between the upper projection and the rear end surface of the first rectangular hole; and
the lower projection of the nut is disposed inside the second rectangular hole so as to form a gap between the lower projection and the front end surface of the second rectangular hole and a gap between the lower projection and the rear end surface of the second rectangular hole.

4. The seat slider as claimed in claim 1, wherein:
the upper face of the nut except for the upper projection and the lower face of the nut except for the lower projection have a distance therebetween that is less than a distance between a lower surface of the ceiling wall of the elastic member and an upper surface of the second upper wall of the second bracket, wherein the ceiling wall of the elastic member is disposed under the first upper wall of the first bracket;
the nut is movable in a vertical direction between the ceiling wall of the elastic member and the second upper wall of the second bracket; and
the upper projection and the lower projection of the nut have heights set to prevent the upper projection and the lower projection from escaping from the first rectangular hole of the first bracket and the second rectangular hole of the second bracket even in case of the vertical move of the nut.
